(19) United States
(12) Patent Application Publication
(10) Pub. No.: US 2011/0162720 A1
(43) Pub. Date: Jul. 7, 2011

(54) SEALING WATER AGENT AND A METHOD OF PIPEWORK MANAGEMENT

(75) Inventor: Harumichi Ueno, Tokyo (JP)

(73) Assignee: KABUSHIKI KAISHA TOPFIELD, Nakano-Ku, Tokyo (JP)

(21) Appl. No.: 13/002,172

(22) PCT Filed: Jun. 30, 2009
(86) PCT No.: PCT/JP2009/003033

§ 371 Date: Mar. 15, 2011

(30) Foreign Application Priority Data
Jul. 1, 2008 (JP) 2008-172847

(51) Int. Cl. F15D 1/00; C09D 191/06; C09D 191/00; C09D 5/16

(52) U.S. Cl. 137/1; 106/270; 106/243; 106/18.29

(57) ABSTRACT

A sealing water agent can prevent evaporation of sealing water. Water alone is conventionally used for sealing water. An oil component and a surfactant can be used for the sealing water agent, which can be applied to a sealing water pipe, effectively preventing evaporation of the scaling water. All oil layers and all emulsified layers can be formed. As a result, the scaling water can be effectively prevented from evaporating. Furthermore, when the sealing water is discharged, the surfactant can emulsify the oil layer so that the sealing water agent can be discharged effectively.

### TECHNICAL FIELD

The present invention relates to a sealing water agent. More specifically, the present invention relates to a sealing water agent which can effectively prevent the evaporation of sealing water and a method of pipework management using the sealing water agent.

### BACKGROUND ART

Drainage pipework in the wash places of bathrooms, washstands, and toilets has a drain trap for preventing the invasion of bad smells and pests from the sewage. Some drain traps have a sealing water chamber which retains the drain to a certain depth and has an opening at the top, and a drain outlet which discharges the drain overflowed from the opening of the sealing water chamber. An inside tube, which is opened to the wash place, is inserted into the sealing water chamber. The drain from the wash place is flown into the sealing water chamber through the opening at the bottom of the inside tube, and discharged through the drain outlet. Further, a drain branch pipe, which is opened to the bathtub, is connected to a side of the sealing water chamber. The drain from the bathtub is flown through the drain branch pipe into the sealing water chamber, and discharged through the drain outlet. The bad smells and pests from the sewage are blocked by the drain retained in the sealing water chamber (hereinafter referred to as sealing water), and thus cannot get indoors (for example, see Patent Document 1).

Evaporation of sealing water can occur in, for example, an apartment which is vacant for a long time, or in a school during a long vacation. Accordingly, bad smells and pests may get indoors.

### PRIOR ART DOCUMENT

### Patent Document

Patent Document 1: Japanese Patent Application Laid-Open No. 2001-182118 (Japan)

### DISCLOSURE OF THE INVENTION

### Problems to be Solved by the Invention

The present invention is intended to provide a “sealing water agent” for preventing the evaporation of sealing water.

### Means for Solving the Problems

Conventionally, water alone was used for the sealing purpose. The present invention dares to use an oil component and a surfactant as a “sealing water agent”. The “sealing water agent” of the present invention refers to an agent which is fed into a sealing water pipe for effectively preventing the evaporation of sealing water. Accordingly, an oil layer and an emulsified layer are formed to effectively prevent the evaporation of sealing water. Further, when the sealing water agent is discharged, the surfactant emulsifies the oil layer, and thus allows effective removal of the sealing water agent.

A first aspect of the present invention relates to a sealing water agent. The sealing water agent contains an oil, water, and a surfactant. Conventionally, a sealing water pipe is filled with water. The water, which is called sealing water, prevents the entry of pests and odors indoors. The present invention dares to put an oil and a surfactant into a sealing water pipe, thereby effectively preventing the evaporation of sealing water. Further, since the sealing water agent contains a surfactant, the oil and water are mixed by the surfactant when water is flushed for removing the sealing water agent, whereby the sealing water agent is removed without clogging of the sealing water pipe. The surfactant is preferably nonionic, thereby preventing the bubbling of the sealing water agent and the adhesion of the oil component of the sealing water agent to the water pipe.

According to a preferred embodiment of the sealing water agent of the present invention, the “oil” is preferably one or more oils selected from spindle oils, trans oils, neutral oils, bright stock oils, petroleum naphtha, gasoline, kerosene, light oils, process oils, liquid paraffins, synthetic ether oils, synthetic polyalkylene glycol oils, synthetic poly alfa olefins, alkylbenzene oils, and silicon oils. Among them, “spindle oils” and “liquid paraffins”, which were examined in the examples, are preferred. More specifically, the oil component of the sealing water agent of the present invention is preferably composed mainly of a spindle oil or liquid paraffin. The sealing water agent may contain other oil besides the spindle oil and liquid paraffin.

According to a preferred embodiment of the sealing water agent of the present invention, the “surfactant” is preferably a polyoxyethylene ether derivative. As examined in the examples, the combination of a liquid paraffin and a polyoxyethylene ether derivative can effectively prevent the evaporation of sealing water. In addition, the combination of a liquid paraffin and a polyoxyethylene ether derivative allows the effective removal of the sealing water agent. The “surfactant” in the present invention may be composed of a first polyoxyethylene ether derivative and/or a second polyoxyethylene ether derivative. It is preferred that the surfactant be composed of the first and second polyoxyethylene ether derivatives.

The first polyoxyethylene ether derivative is expressed by (Formula 1).

R¹-PhO(Ch₂Ch₂O)ₙH (Formula 1)

Wherein in (Formula 1), R¹ represents a linear alkyl group having 5 to 20 carbon atoms or a branched alkyl group having 5 to 20 carbon atoms, Ph represents a phenyl group, and n represents an integer ranging from 2 to 30.

In a preferred example of the first polyoxyethylene ether derivative expressed by (Formula 1), R¹ represents a linear alkyl group having 7 to 11 carbon atoms, or a branched alkyl group having 7 to 11 carbon atoms, Ph represents a phenyl group, and n represents an integer ranging from 3 to 25.

The second polyoxyethylene ether derivative is expressed by (Formula 2).

R²—O(Ch₂Ch₂O)ₘH (Formula 2)

In (Formula 2), R² represents a linear alkyl group having 10 to 30 carbon atoms, or a branched alkyl group having 10 to 30 carbon atoms, Ph represents a phenyl group, and m represents an integer ranging from 2 to 10.

In a preferred example of the second polyoxyethylene ether derivative expressed by (Formula 2), R² represents a linear alkyl group having 16 to 20 carbon atoms or a branched alkyl group having 16 to 20 carbon atoms, Ph represents a phenyl group, and m represents an integer ranging from 3 to 5.

According to a preferred embodiment of the sealing water agent of the present invention, the weight ratio of the oil to the surfactant (oil/surfactant) in the sealing water agent is from 10 to 50. The oil and surfactant contained at this weight ratio can effectively prevent the evaporation of sealing water, and thus allowing effective removal of the sealing water agent. The “weight” and “% by weight” herein may be converted into “mass” and “% by mass”, respectively, in terms of the SI unit.

According to a preferred embodiment of the sealing water agent of the present invention, the “surfactant” is a nonionic surfactant. Examples of the nonionic surfactant include compounds containing an ester bond, compounds containing an ether bond, and compound containing ester and ester bonds. Examples of the surfactant containing an ester bond include those formed through an ester bond between a polyalcohol such as glycerol, sorbitol, or sucrose, and a fatty acid, more specifically, glycerol fatty acid esters, sorbitan fatty acid esters, and sucrose fatty acid esters. Examples of the surfactant containing an ether bond include the above-described polyoxyethylene ether derivatives. In the polyoxyethylene ether derivative, the ethylene oxide may be partially propylene oxide. The hydrophobic group of the polyoxyethylene ether derivative may be polypropylene glycol, thereby further preventing bubbling of the surfactant. Examples of the compound containing ester and ester bonds include ethylene oxide adducts of fatty acid or polyalcohol fatty acid esters. The nonionic surfactant allows effective removal of the sealing water agent, and prevents bubbling of the sealing water agent.

According to a preferred embodiment of the sealing water agent of the present invention, the “oil” and “surfactant” are edible. The term “edible” means, for example, those specified in the Food Sanitation Law of Japan. The edible oils include vegetable oils and animal oils. Examples of vegetable oils include palm oil, almond oil, coconut oil, vegetable oil, Carapa guaianensis seed oil, avocado oil, camellia oil, turtle oil, macadamia nut oil, corn oil, sesame oil, persic oil, wheat germ oil, camellia sasanqua seed oil, castor oil, linseed oil, safflower oil, cottonseed oil, perilla oil, soybean oil, arachis oil, tea oil, kaya oil, rice bran oil, jojoba oil, apricot kernel oil, olive oil, carrot oil, grape seed oil, rapeseed oil, camellia oil, and jojoba oil. Examples of animal oils include egg yolk oil and mink oil. Examples of edible surfactants include saponified products of the above-described edible oils, and fatty acid esters of polyalcohols (for example, sorbitan, sucrose, glycerol, and propylene glycol). When all the components of the sealing water agent are edible, the sealing water agent has high biocompatibility and thus will not damage humans or animals if accidentally swallowed, and its environmental burden is low after decomposed by microorganisms. In the sealing water agent, either of the “oil” of “surfactant” may be edible. In this case, damages caused by accidental swallowing can be minimized, and the environment burden can be lowered.

According to a preferred embodiment of the sealing water agent of the present invention, the sealing water agent further contains a fungicide or antiseptic. In normal cases, the sealing water agent of the present invention is fed into pipework which will not be used for a long period of time and thus may cause the decay of water or the sealing water agent. The addition of a fungicide or antiseptic can prevent the decay of water and others.

A second aspect of the present invention relates to a method for maintaining and managing pipework using the above-described sealing water agent. Specifically, the sealing water agent is fed into an unused sealing water. Accordingly, the sealing water agent stays in the sealing water in the pipework. Since the sealing water agent contains an oil, the oil can prevent the evaporation of sealing water pipe. In addition, since the sealing water agent contains a surfactant, the surfactant emulsifies the oil when water is flushed before using the pipework, whereby the sealing water agent can be effectively removed.

According to a preferred embodiment of the second aspect of the present invention, the “oil” is a spindle oil or liquid paraffin. In addition, the “surfactant” is composed of the first polyoxyethylene ether derivative expressed by Formula 1 and the second polyoxyethylene ether derivative expressed by Formula 2.

R¹-PhO(Ch₂Ch₂O)ₙH (Formula 1)

(wherein in (Formula 1), R¹ represents a linear alkyl group having 7 to 11 carbon atoms or a branched alkyl group having 7 to 11 carbon atoms, Ph represents a phenyl group, and n represents an integer ranging from 3 to 25.)

R²—O(Ch₂Ch₂O)ₘH (Formula 2)

(wherein in (Formula 2), R² represents a linear alkyl group having 16 to 20 carbon atoms or a branched alkyl group having 16 to 20 carbon atoms, Ph represents a phenyl group, and m represents an integer ranging from 3 to 5.)

The weight ratio of the oil to the surfactant (oil/surfactant) in the sealing water agent is from 10 to 50.

As examined in the examples, the sealing water agent can effectively prevent the evaporation of sealing water, and can be effectively removed before using the pipework.

A third aspect of the present invention also relates to a sealing water agent in common with the first aspect. The sealing water agent is placed in a channel of water pipework, and contains an oil, water, and a surfactant, the amount of water being greater than the amount of oil. The surfactant is preferably nonionic. Conventionally, a sealing water pipe is filled with water. The water, which is called sealing water, prevents the entry of pests and odors indoors. The present invention dares to put an oil and a surfactant into a sealing water pipe, thereby effectively preventing the evaporation of sealing water. Further, since the sealing water agent contains a surfactant, the oil and water are mixed by the surfactant when water is flushed for discharging the sealing water agent, whereby the sealing water agent is removed without clogging of the sealing water pipe.

According to a preferred embodiment of the sealing water agent of the present invention, the amount of water is from 3.1 to 20 parts by weight, with respect to 1 part by weight of the oil. Accordingly, the sealing water agent can be thoroughly removed before using the drainage pipework.

According to a preferred embodiment of the sealing water agent of the present invention, the sealing water agent fed into water pipework forms a film on the aqueous layer. The film is removable by flushing water in the water pipework. Accordingly, the film of the sealing water agent can prevent the evaporation of sealing water, and the sealing water agent can be removed before using the drainage pipework.

According to a more preferred embodiment of the sealing water agent of the present invention, the amount of water flushed in the water pipework is at least 5 parts by weight with respect to 1 part by weight of the sealing water agent. Since the sealing water agent contains a surfactant, it can be flushed with such a small amount of water.

A fourth aspect of the present invention relates to, in common with the third aspect, a method for maintaining and managing pipework using the above-described sealing water agent, and specifically to a pipework management method. According to the pipework management method, firstly, the sealing water agent containing an oil, water, and a surfactant, the amount of water being greater than the amount of oil, is fed into unused water pipework. Then, the sealing water agent stays in the sealing water in the pipework. Since the sealing water agent contains an oil, the oil can prevent the evaporation of sealing water. In addition, since the sealing water agent contains a surfactant, the surfactant emulsifies the oil when water is flushed before using the water pipework, whereby the sealing water agent can be effectively removed. The surfactant is preferably nonionic, thereby preventing the bubbling of the sealing water agent and the adhesion of the oil component of the sealing water agent to the water pipe.

According to a more preferred embodiment of the pipework management method of the fourth aspect of the present invention, the amount of water flushed in the water pipework is at least 5 parts by weight with respect to 1 part by weight of the sealing water agent. Since the sealing water agent contains a surfactant, it can be flushed with such a small amount of water.

A fifth aspect of the present invention also relates to a sealing water agent in common with the first and third aspects. The sealing water agent is placed in a channel of water pipework. More specifically, the sealing water agent contains an oil, water, and a surfactant. The amount of water contained in the sealing water agent is greater than the amount of oil, and specifically from 3.1 to 20 parts by weight with respect to 1 part by weight of the oil. Conventionally, a sealing water pipe is filled with water. The water, which is called sealing water, prevents the entry of pests and odors indoors. The present invention dares to put an oil and a surfactant into a sealing water pipe, thereby effectively preventing the evaporation of sealing water. Further, since the sealing water agent contains a surfactant, the oil and water are mixed by the surfactant when water is flushed for discharging the sealing water agent, whereby the sealing water agent is removed without clogging of the sealing water pipe. Further, the amount of water contained in the sealing water agent is from 3.1 to 20 parts by weight with respect to 1 part by weight of the oil, whereby the sealing water agent is thoroughly removed before using the drainage pipework.

A sixth aspect of the present invention also relates to a sealing water agent in common with the first, third, and fifth aspects. The sealing water agent is placed in a channel of water pipework. More specifically, the sealing water agent contains a liquid paraffin as an oil, water, and a polyoxyethylene ether derivative as a surfactant. The amount of water contained in the sealing water agent is greater than the amount of oil. Specifically, the weight ratio of the water to the oil (water/oil) in the sealing water agent is from 3.1 to 20 parts by weight. Further, the weight ratio of the oil to the surfactant (polyoxyethylene ether derivative) (oil/surfactant) in the sealing water agent is from 10 to 50. Conventionally, a sealing water pipe is filled with water. The water, which is called sealing water, prevents the entry of pests and odors indoors. The present invention dares to put a liquid paraffin and a polyoxyethylene ether derivative into a sealing water pipe, thereby effectively preventing the evaporation of sealing water. Further, since the sealing water agent contains a polyoxyethylene ether derivative as a surfactant, the oil and water are mixed by the surfactant when water is flushed for discharging the sealing water agent, whereby the sealing water agent is removed without clogging of the sealing water pipe. Further, the amount of water contained in the sealing water agent is from 3.1 to 20 parts by weight with respect to 1 part by weight of the oil, whereby the sealing water agent is thoroughly removed before using the drainage pipework. The weight ratio of the liquid paraffin to the polyoxyethylene ether derivative (oil/surfactant) in the sealing water agent is from 10 to 50, thereby thoroughly mixing the liquid paraffin and polyoxyethylene ether derivative, and thoroughly discharging the sealing water agent before using the drainage pipework.

### Effects of the Invention

The sealing water agent of the present invention contains an oil component, and the oil component forms a film on the aqueous layer to prevent the evaporation of water. As a result, the entry of pests and odors indoors caused by the evaporation of sealing water can be effectively prevented.

### BRIEF DESCRIPTION OF THE DRAWINGS

FIG. 1 is a photograph corresponding to the drawing showing a sealing water agent obtained.

FIG. 2 is a graph corresponding to the drawing showing the evaporation prevention effect of the sealing water agent.

FIG. 3 lists photographs corresponding to the drawings showing the drain pipe used in the example. FIG. 3A shows an empty drain pipe. FIG. 3B shows the drain pipe filled with water.

FIG. 3C shows a state immediately before charging the sealing water agent. FIG. 3D shows the manner of charging the sealing water agent.

FIG. 4 is a photograph corresponding to the drawing showing the sealing water pipe after charging the sealing water agent. FIGS. 4A, 4B, 4C, 4D, 4E, and 4F show the sealing water pipe after a lapse of 1 minute, 5 minutes, 10 minutes, 30 minutes, 12 hours, and 24 hours, respectively.

FIG. 5 lists photographs corresponding to the drawings showing the manner of discharging the sealing water agent. FIG. 5A shows the setup of discharging the sealing water agent, and FIG. 5B shows the condition after the sealing water agent was removed.

### BEST MODE FOR CARRYING OUT THE INVENTION

The first aspect of the present invention relates to a sealing water agent. The sealing water agent contains an oil, water, and a surfactant. Conventionally, a sealing water pipe is filled with water. The water, which is called sealing water, prevents the entry of pests and odors indoors. The present invention dares to put an oil and a surfactant into a sealing water pipe, thereby effectively preventing the evaporation of sealing water. Further, since the sealing water agent contains a surfactant, the oil and water are mixed by the surfactant when water is flushed for discharging the sealing water agent, whereby the sealing water agent is removed without clogging of the sealing water pipe. The surfactant is preferably nonionic, thereby preventing the bubbling of the sealing water agent and the adhesion of the oil component of the sealing water agent to the water pipe.

The “sealing water pipe” herein includes the sealing water pipes installed in water pipes of counters or washstands, and the sealing water pipes installed in the drain part of toilets.

According to a preferred embodiment of the sealing water agent of the present invention, the “oil” is preferably one or more oils selected from spindle oils trans oils, neutral oils, bright stock oils, petroleum naphtha, gasoline, kerosene, light oils, process oils, liquid paraffins, synthetic ether oils, synthetic polyalkylene glycol oils, synthetic poly alfa olefins, alkylbenzene oils, and silicon oils. Among them, “spindle oils” and “liquid paraffins”, which were examined in the examples, are preferred. More specifically, the oil component of the sealing water agent of the present invention is preferably composed mainly of a spindle oil or liquid paraffin. The sealing water agent may contain other oil besides the spindle oil and liquid paraffin.

According to a preferred embodiment of the sealing water agent of the present invention, the “surfactant” is preferably a polyoxyethylene ether derivative. As examined in the examples, the combination of a liquid paraffin and a polyoxyethylene ether derivative can effectively prevent the evaporation of sealing water. In addition, the combination of a liquid paraffin and a polyoxyethylene ether derivative allows effective removal of the sealing water agent. The “surfactant” in the present invention may be composed of a first polyoxyethylene ether derivative and/or a second polyoxyethylene ether derivative. It is preferred that the surfactant be composed of the first and second polyoxyethylene ether derivatives.

The first polyoxyethylene ether derivative is expressed by (Formula 1).

R¹-PhO(Ch₂Ch₂O)ₙH (Formula 1)

Wherein in (Formula 1), R¹ represents a linear alkyl group having 5 to 20 carbon atoms or a branched alkyl group having 5 to 20 carbon atoms, Ph represents a phenyl group, and n represents an integer ranging from 2 to 30.

In a preferred example of the first polyoxyethylene ether derivative expressed by (Formula 1), R¹ represents a linear alkyl group having 7 to 11 carbon atoms, or a branched alkyl group having 7 to 11 carbon atoms, Ph represents a phenyl group, and n represents an integer ranging from 3 to 25.

Even more preferably, the first polyoxyethylene ether derivative is polyoxyethylene nonyl phenyl ether (C₉H₁₉-PhO(Ch₂Ch₂O)ₙH).

In (Formula 1), the R¹— group in “R¹-PhO” may be located ortho, meta, or para to the O— group. Of these, the R¹— group is preferably located para to the O— group.

The molecular weight distribution of the first polyoxyethylene ether derivative is preferably broader than that of the second polyoxyethylene ether derivative. In order to achieve this, the first polyoxyethylene ether derivative is preferably composed of a plurality of polyoxyethylene ether derivatives. Specifically, the peaks of the weight average molecular weight distributions are preferably located in the three regions wherein n is from 3 to 5, from 14 to 16, and from 19 to 21. According to a specific example, the peaks are located at certain molecular weights of polyoxyethylene nonyl phenyl ether in the analysis of the components contained in the sealing water agent by light scattering or other method.

The second polyoxyethylene ether derivative is expressed by (Formula 2).

R²—O(Ch₂Ch₂O)ₘH (Formula 2)

In (Formula 2), R² represents a linear alkyl group having 10 to 30 carbon atoms, or a branched alkyl group having 10 to 30 carbon atoms, Ph represents a phenyl group, and m represents an integer ranging from 2 to 10.

In a preferred example of the second polyoxyethylene ether derivative expressed by (Formula 2), R² represents a linear alkyl group having 16 to 20 carbon atoms or a branched alkyl group having 16 to 20 carbon atoms, Ph represents a phenyl group, and m represents an integer ranging from 3 to 5.

The second polyoxyethylene ether derivative is even more preferably polyoxyethylene oleyl ether (C₁₈H₃₅—O(Ch₂Ch₂O)ₘH).

When the sealing water agent of the present invention is composed of the first and second polyoxyethylene ether derivatives, the weight ratio of the first to second polyoxyethylene ether derivative may be from 1 to 10, or from 2 to 5. In the first and second polyoxyethylene ether derivatives, the ethylene oxide may be partially propylene oxide. The hydrophobic group of the polyoxyethylene ether derivative may be polypropylene glycol, thereby further preventing bubbling of the surfactant. When the carbon number of the lipophilic part of the polyoxyethylene ether derivative is close to the carbon number of the oil component in the sealing water agent, the surfactant is well mixed with the oil component. On the other hand, if the carbon number of the lipophilic part of the polyoxyethylene ether derivative is too close to the carbon number of the oil component in the sealing water agent, the surfactant will not be separated from the oil component after emulsification. Accordingly, it is most preferred that the surfactant be the above-described polyoxyethylene ether derivative.

According to a preferred embodiment of the sealing water agent of the present invention, the “surfactant” is a nonionic surfactant. Examples of the nonionic surfactant include compounds containing an ester bond, compounds containing an ether bond, and compound containing ester and ester bonds. Examples of the surfactant containing an ester bond include those formed through an ester bond between a polyalcohol such as glycerol, sorbitol, or sucrose, and a fatty acid, more specifically, glycerol fatty acid esters, sorbitan fatty acid esters, and sucrose fatty acid esters. Examples of the surfactant containing an ether bond include the above-described first and second polyoxyethylene ether derivatives. Examples of the compound containing ester and ester bonds include ethylene oxide adducts of fatty acid or polyalcohol fatty acid esters. The nonionic surfactant allows effective removal of the sealing water agent, and prevents bubbling of the sealing water agent.

According to a preferred embodiment of the sealing water agent of the present invention, the “oil” and “surfactant” are edible. The term “edible” means, for example, those specified in the Food Sanitation Law of Japan. The edible oils include vegetable oils and animal oils. Examples of vegetable oils include palm oil, almond oil, coconut oil, vegetable oil, Carapa guaianensis seed oil, avocado oil, camellia oil, turtle oil, macadamia nut oil, corn oil, sesame oil, persic oil, wheat germ oil, camellia sasanqua seed oil, castor oil, linseed oil, safflower oil, cottonseed oil, perilla oil, soybean oil, arachis oil, tea oil, kaya oil, rice bran oil, jojoba oil, apricot kernel oil, olive oil, carrot oil, grape seed oil, rapeseed oil, camellia oil, and jojoba oil. Examples of animal oils include egg yolk oil and mink oil. Examples of edible surfactants include saponified products of the above-described edible oils, and fatty acid esters of polyalcohols (for example, sorbitan, sucrose, glycerol, and propylene glycol). When all the components of the sealing water agent are edible, the sealing water agent has high biocompatibility and thus will not damage humans or animals if accidentally swallowed, and its environmental burden is low after decomposed by microorganisms. In the sealing water agent, either of the “oil” of “surfactant” may be edible. In this case, damages caused by accidental swallowing is minimized, and the environment burden is low.

According to a preferred embodiment of the sealing water agent of the present invention, the weight ratio of the oil to the surfactant (oil/surfactant) in the sealing water agent is from 10 to 50. Since the sealing water agent contains the oil and surfactant at this weight ratio, it can effectively prevent the evaporation of sealing water, and can be effectively removed before using the pipework. The sealing water agent may be appropriately diluted with water before use. When the sealing water agent is diluted with water, the weight ratio of the oil to the surfactant is preferably within the above-described range. The weight ratio of the oil to the surfactant is based on the result of out investigation for reliably achieving the above-described effect, regardless who feeds the sealing water agent in a roughly estimate amount (for example, 50 cc) to any sealing water. The amount of the sealing water agent may be appropriately adjusted according to the amount of water in the sealing water pipe. The weight ratio of the oil to the surfactant may be from 20 to 30.

According to a preferred embodiment of the sealing water agent of the present invention, the amount of water contained in the sealing water agent is greater than the amount of oil. Accordingly, a water-in-oil (W/O) emulsion can be readily formed. Therefore, the sealing water agent of the present invention can be readily removed by the water flown in the water pipe. Specifically, the present invention positively uses the water flown in water pipe. According to a more preferred embodiment, the amount of water is from 3.1 to 20 parts by weight with respect to 1 part by weight of the oil. Specifically, the weight ratio of the water and oil (water/oil) in the sealing water agent is from 3.1 to 20 parts by weight. Accordingly, the sealing water agent can be thoroughly removed before using the drainage pipework. Since the sealing water agent is readily removed, no residue of the oil component of the sealing water agent will be left in the water pipe. When the proportion of the water contained in the sealing water agent is excessively high, the amount of the oil component decreases. Accordingly, the upper limit of the amount of water contained in the sealing water agent is, for example, 20 parts by weight with respect to 1 part by weight of the oil. It is needless to say that the upper limit of the proportion of water depends on the diameter of the water pipe and the volume of sealing water in the water pipe.

According to a most preferred embodiment of the sealing water agent of the present invention, the oil and surfactant contained in the sealing water agent are a liquid paraffin and a polyoxyethylene ether derivative, respectively. The liquid paraffin and polyoxyethylene ether derivative are well mixed with each other because their carbon chain lengths are relatively close, and thus forming a good emulsion. As a result, the sealing water agent can be thoroughly removed before using the drainage pipework. Even more preferably, in the sealing water agent, the weight ratio of the liquid paraffin to the polyoxyethylene ether derivative (oil/surfactant) is from 10 to 50. As a result, the liquid paraffin can be thoroughly mixed with the polyoxyethylene ether derivative. More preferably, the weight ratio of the water to the liquid paraffin (water/oil) in the sealing water agent is from 3.1 to 20 parts by weight. Accordingly, the liquid paraffin is well mixed with the polyoxyethylene ether derivative to form a good emulsion. The use of a polyoxyethylene ether derivative as the surfactant inhibits bubbling of the sealing water agent. The reason for this is that the polyoxyethylene ether derivative is a nonionic surfactant, so that its emulsion has no electrostatic repulsive force. The inhibition of bubbling (foamability) of the sealing water agent can contribute to the prevention of the adherence of the oil component to the water pipe. In the most preferred embodiment, the liquid paraffin may be replaced with a spindle oil.

According to a preferred embodiment of the sealing water agent of the present invention, the sealing water agent further contains a fungicide or antiseptic. In normal cases, the sealing water agent of the present invention is fed into pipework which will not be used for a long period of time and thus may cause the decay of water or the sealing water agent. The addition of a fungicide or antiseptic can prevent the decay of water and the like. Known fungicide and antiseptic can be appropriately used.

The sealing water agent of the present invention can be prepared by mixing the above ingredients. The sealing water agent may further contain additives such as a stain and a perfume.

The second aspect of the present invention relates to a method for maintaining and managing pipework using the above-described sealing water agent. Specifically, the sealing water agent is fed into an unused sealing water pipe. It is preferred that the sealing water agent be thoroughly stirred before use, and a single dose is preferably about 50 cc. Accordingly, the sealing water agent stays in the sealing water in the pipework. Since the sealing water agent contains an oil, the oil can prevent the evaporation of sealing water. In addition, since the sealing water agent contains a surfactant, the surfactant emulsifies the oil when water is flushed before using the water pipework, whereby the sealing water agent is effectively removed.

The second aspect of the present invention may use any embodiment of the sealing water agent described above. As examined in the examples, the sealing water agent can effectively prevent the evaporation of sealing water, and can be effectively removed before using the pipework.

### Example 1

A sealing water agent was prepared according to the following composition. The stock solution of the sealing water agent was composed of 76% by weight of water and a perfume, 23% by weight of a liquid paraffin, and 1% by weight of a surfactant. To the stock solution, trace amounts of an antiseptic and a dye were added. The perfume was a peppermint flavor manufactured by Ogawa & Co., Ltd. The liquid paraffin was HIGH-WHITE 70 manufactured by Nippon Oil Corporation. HIGH-WHITE 70 is a petroleum-derived liquid paraffin having a hydrocarbon content of 100%. The surfactant was a mixture of NONIPOL 40, NONIPOL 200 manufactured by Sanyo Chemical Industries, Ltd., NP-EOA70 manufactured by Miyoshi Oil & Fat Co., Ltd., and EN-1504 manufactured by Aoki Oil Industrial Co., Ltd. NONIPOL 40 is a polyoxyethylene nonyl phenyl ether having an average number of added moles of about 4. NONIPOL 200 is a polyoxyethylene nonyl phenyl ether having an average number of added moles of about 20. NP-EOA70 is a polyoxyethylene nonyl phenyl ether having an average number of added moles of less than 15. EN-1504 is a polyoxyethylene oleyl ether having an average number of added moles of 4. The antiseptic was PROXEL2(S) manufactured by Arch Chemicals Japan, Inc. The dye was KAYANOL MILLING TURQUOISE BLUE3G (Acid Blue 185) manufactured by Nippon Kayaku Co., Ltd.

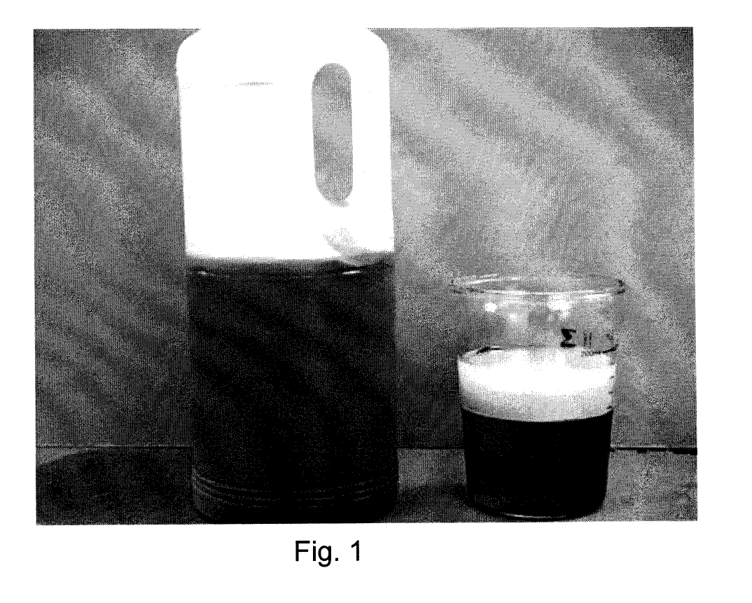

These ingredients were mixed, and thus obtaining a sealing water agent having two liquid phases. FIG. 1 is a photograph corresponding to the drawing showing the sealing water agent obtained.

### Example 2

A sealing water agent was prepared in the same manner as in Example 1, except that a spindle oil was used in place of the liquid paraffin in Example 1.

### Example 3

### Evaporation Prevention Test

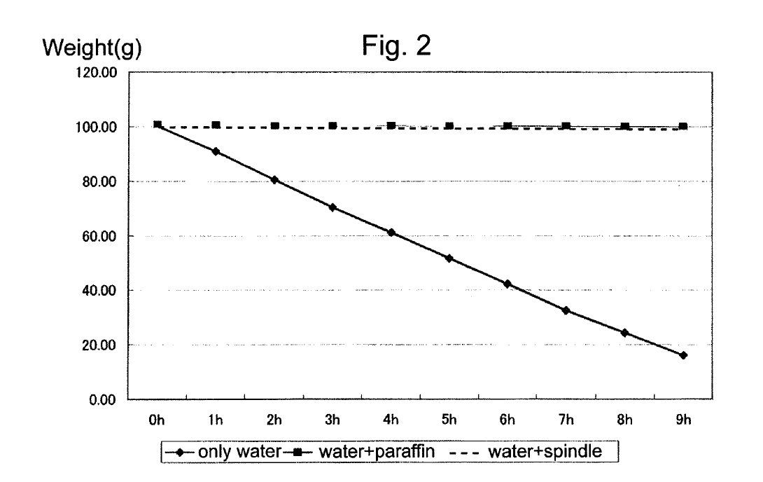

100 g of the sealing water agent prepared in Example 1, 100 g of the sealing water agent prepared in Example 2, and 100 g of the aqueous solution containing no liquid paraffin prepared in Example 1 were placed in a 300-cc beaker. The evaporation of water was observed in an atmosphere at 105° C. The results are shown in Tables 1 and 2. FIG. 2 is a graph corresponding to the drawing showing the evaporation prevention effect of the sealing water agent.

TABLE 1

| | 0 h | 1 h | 2 h | 3 h | 4 h | 5 h | 6 h | 7 h | 8 h | 9 h |
|---|---|---|---|---|---|---|---|---|---|---|
| Aqueous solution | 100.00 | 90.75 | 80.27 | 70.29 | 61.01 | 51.59 | 42.22 | 32.56 | 24.45 | 16.27 |
| alone | | | | | | | | | | |
| Aqueous solution + | 100.00 | 99.94 | 99.89 | 99.89 | 99.81 | 99.79 | 99.75 | 99.70 | 99.58 | 99.50 |
| paraffin | | | | | | | | | | |
| Aqueous solution + | 100.00 | 99.93 | 99.89 | 99.81 | 99.77 | 99.70 | 99.63 | 99.54 | 99.40 | 99.33 |
| spindle | | | | | | | | | | |

In Table 1, “aqueous solution alone” represents the control experiment. In Table 1, “aqueous solution+paraffin” represents the sealing water agent prepared in Example 1. In Table 1, “aqueous solution+spindle” represents the sealing water agent prepared in Example 2. Table 1 or FIG. 2 indicates that the addition of the sealing water agent of the present invention prevented the evaporation of water even under heating.

### Example 4

### Confirmation Test of the Working Condition of the Sealing Water Agent

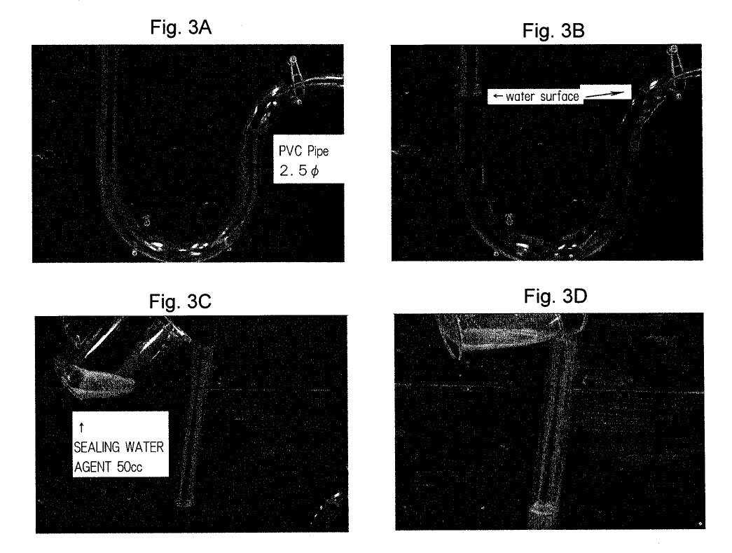

Subsequently, an experiment for confirming the working condition of the sealing water agent was carried out. In this experiment, the sealing water agent prepared in Example 1 was used. FIG. 3 lists photographs corresponding to the drawings showing the drain pipe used in the example. FIG. 3A shows an empty drain pipe. FIG. 3B shows the drain pipe filled with water. FIG. 3C shows a state immediately before charging the sealing water agent. FIG. 3D shows the manner of charging the sealing water agent. As indicated by FIG. 3A, a vinyl chloride pipe having a diameter of 2.5 cm was used in this example. Since the vinyl chloride pipe is transparent, the condition in the pipe can be seen. As indicated by FIG. 3B, the pipe was filled with tap water. Before feeding the sealing water agent into the pipe, the sealing water agent was thoroughly stirred. Before stirring, the sealing water agent was separated into an oil layer and an aqueous layer (and an emulsified layer). However, after stirring, as indicated by FIG. 3C, the sealing water agent was in a foamed state. FIG. 3D shows the manner of charging the sealing water agent. In this example, the sealing water agent was fed using a beaker. In practical use, a special vessel or the like may be used for feeding the sealing water agent.

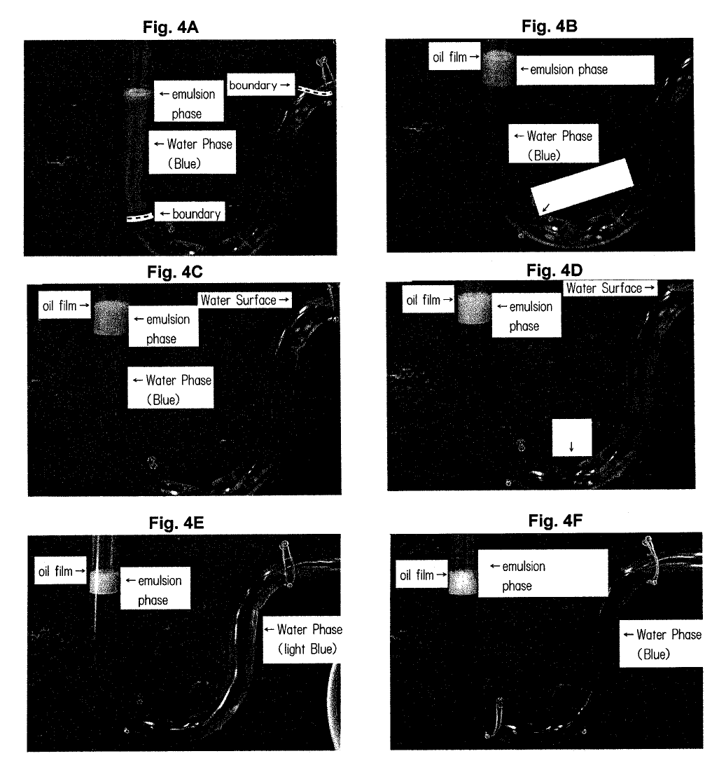

FIG. 4 is a photograph corresponding to the drawing showing the sealing water pipe after charging the sealing water agent. FIGS. 4A, 4B, 4C, 4D, 4E, and 4F show the sealing water pipe after a lapse of 1 minute, 5 minutes, 10 minutes, 30 minutes, 12 hours, and 24 hours, respectively. As indicated by FIG. 4A, an aqueous layer (practically colored in blue) and an emulsified layer were formed 1 minute after charging the sealing water agent. As indicated by FIG. 4B, an oil film was formed 5 minutes after charging the sealing water agent. As indicated by FIGS. 4C and 4D, the aqueous layer dissolved in the tap water gradually. As indicated by FIG. 4E, the aqueous layer spread all over the tap water 12 hours after charging the sealing water agent, though the aqueous layer was not completely uniform. On the other hand, the oil film and emulsified layer were clearly formed. As indicated by FIG. 4F, the aqueous layer spread all over the tap water 24 hours after charging the sealing water agent, though the aqueous layer was not completely uniform.

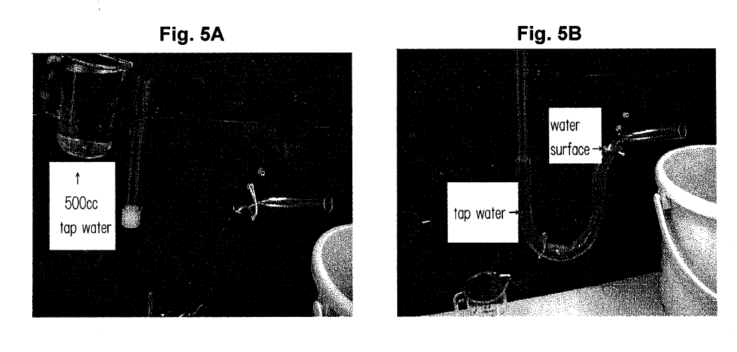

FIG. 5 lists photographs corresponding to the drawings showing the manner of discharging the sealing water agent. FIG. 5A shows the setup of discharging the sealing water agent, and FIG. 5B shows the condition after the sealing water agent was removed. As indicated by FIG. 5A, 500 cc of tap water was used for removing the sealing water agent. As indicated by FIG. 5B, the sealing water agent was almost completely removed with the 500 cc of tap water.

### Example 5

### Optimization of the Ratio Between Water and Oil

In order optimize the mixing ratio of the water to oil contained in the sealing water agent, different mixing proportions were tested. Specifically, in the sealing water agent, the weight of water (parts by weight) was changed with the weights of the liquid paraffin (oil) and polyoxyethylene ether derivative (surfactant) unchanged. Each of the sealing water agents thus obtained was homogenized by stirring, and then 100 g of the agent was fed into the sealing water trap of the water pipe. Subsequently, water was flushed in the water pipe with the intention of removing the sealing water agent. In this manner, in Example 5, removability of the sealing water agents was tested. The results are shown in Table 2.

The “removability” in Table 2 means whether the sealing water agent was removed by 10 parts by weight of water. Specifically, when the sealing water agent was removed by 5 parts by weight of water, 10 parts by weight of water, 10 parts by weight or more of water, and 30 parts by weight or more of water, the removability was rated as best “ [symbol] ”, sufficient “◯”, rather poor “Δ”, and poor “x”, respectively.

TABLE 2

| | Sealing water agent No. | | | | | | |
|---|---|---|---|---|---|---|---|
| | 5a | 5b | 5c | 5d | 5e | 5f | 5g |
| 1 parts by weight of | 49.5 | 39.6 | 24.8 | 24.1 | 23 | 9.9 | 4.7 |
| oil (% by weight) | | | | | | | |
| 0.04 parts by weight | 1 | 1 | 1 | 1 | 1 | 1 | 1 |
| of surfactant (% by | | | | | | | |
| weight) | | | | | | | |
| Water (% by weight) | 49.5 | 59.4 | 74.2 | 74.9 | 76 | 89.1 | 94.3 |
| Water (parts by weight | 1 | 1.5 | 3 | 3.1 | 3.3 | 9 | 20 |
| to oil) | | | | | | | |
| Removability | X | Δ | Δ | ◯ | [symbol] | [symbol] | [symbol] |

As indicated by Table 2, the sealing water agent exhibited the best removability when the weight ratio of the water to the oil (water/oil) contained in the sealing water agent was 3.3 parts by weight or more. When the ratio was 3.1 parts by weight or more, the sealing water agent exhibited sufficient removability. Specifically, it was found that the weight ratio of water to the oil (water/oil) contained in the sealing water agent is preferably 3.1 or more, and most preferably 3.3 or more. It is needless to say that if the proportion of the water contained in the sealing water agent is excessively high, the amount of the oil component decreases, and the sealing water agent will not work. Further, in Example 5, the spindle oil achieved a comparable effect to the liquid paraffin.

### INDUSTRIAL APPLICABILITY

The present invention relates to a novel sealing water agent, and thus is useful in the field of construction chemicals.

1. A sealing water agent which comprises oil, water and a surfactant.

2. The sealing water agent in accordance with claim 1,
wherein the oil is one or more oils selected from the group of “spindle oil, trans oil, neutral oil, bright stock oil, petroleum naphtha, gasoline, kerosene, light oil, process oil, liquid paraffin, synthetic ether oil, synthetic polyalkylene glycol oil, synthetic poly alpha olefin, alkylbenzene oil, and silicon oil”

3. The sealing water agent in accordance with claim 1,
wherein the oil is spindle oil or liquid paraffin.

4. The sealing water agent in accordance with claim 1,
wherein the surfactant comprises polyoxyethylene ether derivative.

5. The sealing water agent in accordance with claim 1,
wherein the surfactant comprises one of or both of a first polyoxyethylene ether derivative expressed by Formula 1 and a second polyoxyethylene ether derivative expressed by Formula 2;
R¹-PhO(Ch₂Ch₂O)ₙH (Formula 1)
wherein in Formula 1, R¹ represents a linear alkyl group having 5 to 20 carbon atoms or a branched alkyl group having 5 to 20 carbon atoms, Ph represents a phenyl group, and n represents an integer ranging from 2 to 30;
R²—O(Ch₂Ch₂O)ₘH (Formula 2)
wherein in Formula 2, R² represents a linear alkyl group having 10 to 30 carbon atoms, or a branched alkyl group having 10 to 30 carbon atoms, Ph represents a phenyl group, and m represents an integer ranging from 2 to 10.

6. The sealing water agent in accordance with claim 1,
wherein the surfactant comprises one of or both of a first polyoxyethylene ether derivative expressed by Formula 1 and a second polyoxyethylene ether derivative expressed by Formula 2;
R¹-PhO(Ch₂Ch₂O)ₙH (Formula 1)
wherein in Formula 1, R¹ represents a linear alkyl group having 7 to 11 carbon atoms or a branched alkyl group having 7 to 11 carbon atoms, Ph represents a phenyl group, and n represents an integer ranging from 3 to 25;
R²—O(Ch₂Ch₂O)ₘH (Formula 2)
wherein in Formula 2, R² represents a linear alkyl group having 16 to 20 carbon atoms, or a branched alkyl group having 16 to 20 carbon atoms, Ph represents a phenyl group, and m represents an integer ranging from 3 to 5.

7. The sealing water agent in accordance with claim 1,
wherein the oil and surfactant are edible,
wherein the oil is vegetable oil or animal oil, and
wherein the surfactant is saponified product of the oil or fatty acid ester of polyalcohol.

8. The sealing water agent in accordance with claim 1,
wherein the weight ratio of the oil to the surfactant in the sealing water agent is from 10 to 50.

9. The sealing water agent in accordance with claim 1, further comprising a fungicide or antiseptic.

10. A method for preventing sealing water in a sealing water pipe from evaporating, the method comprising a step of pouring a sealing water agent, the agent comprising oil, water and nonionic surfactant.

11. The method in accordance with claim 10,
wherein the surfactant comprises one of or both of a first polyoxyethylene ether derivative expressed by Formula 1 and a second polyoxyethylene ether derivative expressed by Formula 2;
R¹-PhO(Ch₂Ch₂O)ₙH (Formula 1)
wherein in Formula 1, R¹ represents a linear alkyl group having 5 to 20 carbon atoms or a branched alkyl group having 5 to 20 carbon atoms, Ph represents a phenyl group, and n represents an integer ranging from 2 to 30;
R²—O(Ch₂Ch₂O)ₘH (Formula 2)
wherein in Formula 2, R² represents a linear alkyl group having 10 to 30 carbon atoms, or a branched alkyl group having 10 to 30 carbon atoms, Ph represents a phenyl group, and m represents an integer ranging from 2 to 10.

12. The sealing water agent in accordance with claim 1,
wherein the amount of water is greater than the amount of oil, and
wherein the sealing water agent is used to prevent a sealing water from vaporizing by pouring the sealing water agent into a channel of water pipework.

13. The sealing water agent in accordance with claim 12, wherein the amount of the water is from 3.1 to 20 times of the amount of the oil.

14. The sealing water agent in accordance with claim 12,
wherein the agent forms a film on an aqueous layer of a sealing water in the channel when the agent is fed into the sealing water, and
wherein the film is removable by flushing water in the water pipework.

15. The sealing water agent in accordance with claim 14,
wherein the amount of water flushed in the water pipework is at least 5 times of the amount of the sealing water agent.

16. (canceled)

17. The method
in accordance with claim 10, further comprising a step of removing the sealing water agent by flushing water in the water pipework.

18. The method in accordance with claim 17,
wherein the amount of water flushed in the water pipework is at least 5 times of the amount of the sealing water agent.

19. The sealing water agent in accordance with claim 1,
wherein the sealing water agent is used to prevent a sealing water from vaporizing by pouring the sealing water agent into a channel of water pipework.

20. (canceled)

21. The sealing water agent in accordance with claim 1, wherein the oil comprises liquid paraffin, and the surfactant comprises polyoxyethylene ether derivative,
wherein the amount of the water is larger than the amount of the liquid paraffin,
wherein the amount of the water is from 3.1 to 20 times of the amount of the liquid paraffin, and
wherein the amount of the liquid paraffin is from 10 to 50 times of the amount of the polyoxyethylene ether derivative, and
wherein the sealing water agent is used to prevent a sealing water from vaporizing by pouring the sealing water agent into a channel of water pipework.

22. The sealing water agent in accordance with claim 13,
wherein the agent forms a film on an aqueous layer of a sealing water in the channel when the agent is fed into the sealing water, and
wherein the film is removable by flushing water in the water pipework.
